(19) United States
(12) Patent Application Publication
(10) Pub. No.: US 2025/0231272 A1
(43) Pub. Date: Jul. 17, 2025

(54) PROCESSOR FOR PERFORMING RADAR AND COMMUNICATION OPERATIONS, AN ELECTRONIC DEVICE, A METHOD, A COMPUTER PROGRAM PRODUCT, AND A PRIORITIZATION CONTROL UNIT

(71) Applicant: BEAMMWAVE AB, Lund (SE)

(72) Inventor: Bengt Lindoff, Bjärred (SE)

(21) Appl. No.: 18/701,426

(22) PCT Filed: Oct. 10, 2022
(86) PCT No.: PCT/SE2022/050913

§ 371 Date: Apr. 15, 2024

(30) Foreign Application Priority Data
Oct. 26, 2021 (SE) 2130287-2

(51) Int. Cl. G01S 7/00; G01S 7/02; H04W 72/12; H04W 72/566

(52) U.S. Cl. CPC G01S 7/006; G01S 7/023; H04W 72/1215; H04W 72/569

(57) ABSTRACT

A processor (100) for performing radar and communication operations, connectable to a radio transceiver (110) capable of transmitting radar and communication radio signals over at least a first and a second frequency range, the processor (100) comprising: a signal generator (120) configured to generate communication signals and radar signals; a communication control unit (130) configured to control a first time period and the first frequency range for transmitting communication signals generated by the signal generator (120); a radar control unit (140) configured to control a second time period and the second frequency range for transmitting radar signals generated by the signal generator (120); and a prioritization control unit (150) configured to receive the first time period and the first frequency range from the communication control unit (130), configured to receive the second time period and the second frequency range from the radar control unit (140), configured to determine if the first and second time periods at least partially overlap, configured to determine if the first and second frequency ranges at least partially overlap and configured to prioritize transmission of communication signals or transmission of radar signals based on a prioritization rule if the first and second time periods at least partially overlap and the first and second frequency ranges at least partially overlap. Corresponding electronic device, method, computer program product and prioritization control unit are also disclosed.

### TECHNICAL FIELD

The present disclosure relates to a processor for performing radar and communication operations, an electronic device, a method, a computer program product, and a prioritization control unit. More specifically, the disclosure relates to a processor for performing radar and communication operations, an electronic device, a method, a computer program product, and a prioritization control unit as defined in the introductory parts of the independent claims.

### BACKGROUND ART

The spectrum for radio signals is limited. Therefore, communication between user equipment, e.g., cell phones or mobile phones, may utilize the same radio spectrum for communication with base stations and other functions, such as back scattering signalling or radar. However, when the same radio spectrum is utilized for communication with base stations and other functions there is a risk of interference.

A device for coordinating operation of a separate radar unit and a separate wireless communication unit, both separate units comprised in the device, is known from WO 2020/126050 A1. The device enables the radar unit to detect interference and thereby to mitigate the interference or reduce risk of being interfered and causing inference.

EP 3865896 A1 discloses a method for operating a radar system in a vehicle by transmitting a communications signal with a separate communications transceiver and a radar signal with a separate radar transceiver in the same time-frequency resource, i.e., in the time-frequency resource granted for the communications signal. Furthermore, the radar signals and the communications signals are transmitted as different radio signals in separate radio beams and in different directions. Thus, circuitry for setting and checking directions is needed in order to ensure that radar signals and communications signals do not interfere. Therefore, the radar system described in EP 3865896 A1 may be complex. Thus, there may be a need for less complex solutions.

US 2018/0095161 A1 discloses a radar system concurrently/simultaneously sending radar and LTE communication signals. However, the LTE waveform and the radar waveform appears to either always utilize different frequencies or the radar waveform is always scheduled when there is no LTE waveform. Thus, the radar system of US 2018/0095161 A1 requires a scheduler and is therefore complex. Therefore, there may be a need for less complex solutions.

Moreover, prior art devices such as the ones disclosed in WO 2020/126050 A1 and EP 3865896 A1, utilizing a separate radar unit and a separate wireless communication unit, are complex and may not be energy efficient. Thus, there may be a need for less complex solutions and/or more energy efficient solutions.

### SUMMARY

An object of the present disclosure is to mitigate, alleviate or eliminate one or more of the above-identified deficiencies and disadvantages in the prior art and solve at least the above-mentioned problem.

According to a first aspect there is provided a processor for performing radar and communication operations, connectable to a radio transceiver capable of transmitting radar and communication radio signals over at least a first and a second frequency range. The processor comprises: a signal generator configured to generate communication signals and radar signals; a communication control unit configured to control a first time period and the first frequency range for transmitting communication signals generated by the signal generator; a radar control unit configured to control a second time period and the second frequency range for transmitting radar signals generated by the signal generator; and a prioritization control unit. The prioritization control unit is configured to receive the first time period and the first frequency range from the communication control unit, configured to receive the second time period and the second frequency range from the radar control unit, configured to determine if the first and second time periods at least partially overlap, configured to determine if the first and second frequency ranges at least partially overlap and configured to prioritize transmission of communication signals or transmission of radar signals based on a prioritization rule if the first and second time periods at least partially overlap and the first and second frequency ranges at least partially overlap.

According to some embodiments, the prioritization rule is a pre-defined prioritization rule.

According to some embodiments, the pre-defined prioritization rule is according to a standard, such as 5G or 6G.

According to some embodiments, the pre-defined prioritization rule is based on previously transmitted radar and/or communication signals.

According to some embodiments, the pre-defined prioritization rule is based on a type of data packet.

According to some embodiments, the pre-defined prioritization rule is based on whether/if the communication signals comprise one or more data packet of a first type.

According to some embodiments, the pre-defined prioritization rule states that if the communication signals comprise one or more data packet of a first type, transmission of communication signals will be prioritized over transmission of radar signals.

According to some embodiments, the pre-defined prioritization rule further states that if the communication signals do not comprise one or more data packet of a first type, transmission of radar signals will be prioritized over transmission of communication signals.

According to some embodiments, the data packet of the first type is a retransmission data packet.

According to some embodiments, the data packet of the first type is a low latency constraints data packet.

According to some embodiments, the data packet of the first type is a low latency constraints data packet or a retransmission data packet. According to some embodiments, the pre-defined prioritization rule is based on a random number.

According to some embodiments, the pre-defined prioritization rule states that transmission of communication signals is always prioritized over transmission of radar signals.

According to some embodiments, the pre-defined prioritization rule states that transmission of radar signals is prioritized over transmission of communication signals for a time period after a first radar signal has been transmitted.

According to some embodiments, the pre-defined prioritization rule states that transmission of radar signals is always prioritized over transmission of communication signals.

According to some embodiments, the communication control unit is configured to control a third time period and a third frequency range for receiving communication signals.

According to some embodiments, the radar control unit is configured to control the second time period and the second frequency range for receiving radar signals.

According to some embodiments, the prioritization control unit is configured to receive the third time period and the third frequency range from the communication control unit; and the prioritization control unit is configured to determine if any of the first, second, and third time periods at least partially overlap, configured to determine if any of the first, second, and third frequency ranges at least partially overlap and configured to prioritize transmission of communication signals, transmission of radar signals, reception of communication signals or reception of radar signals based on one or more pre-defined prioritization rules if any of the first, second, and third time periods at least partially overlap and a corresponding first, second, or third frequency range at least partially overlap.

According to a second aspect there is provided an electronic device comprising the processor of the first aspect or any of the above-mentioned embodiments and a radio transceiver configured to transmit radar and communication radio signals over at least the first and the second frequency ranges.

According to some embodiments, the radio transceiver consists of a single radio transceiver, and the single radio transceiver is configured to transmit and/or receive both radar and communication radio signals.

According to some embodiments, the radio transceiver consists of a single radio transmitter, and the single radio transmitter is configured to transmit both radar and communication radio signals.

According to some embodiments, the electronic device is a smartphone.

According to a third aspect there is provided a method for a digital processor. The method comprises: generating communication signals and radar signals; controlling a first time period and a first frequency range for transmitting communication signals generated by the signal generator; controlling a second time period and a second frequency range for transmitting radar signals generated by the signal generator; determining if the first and second time periods at least partially overlap; determining if the first and second frequency ranges at least partially overlap; and prioritizing transmission of communication signals or transmission of radar signals based on a pre-defined prioritization rule if the first and second time periods at least partially overlap and the first and second frequency ranges at least partially overlap.

According to some embodiments, the pre-defined prioritization rule is according to a standard, such as 5G or 6G.

According to a fourth aspect there is provided a computer program product comprising a non-transitory computer readable medium, having stored there on a computer program comprising program instructions, the computer program being loadable into a data processing unit and configured to cause execution of the method of the third aspect when the computer program is run by the data processing unit.

According to some embodiments, the pre-defined prioritization rule is according to a standard, such as 5G or 6G.

According to a fifth aspect there is provided a prioritization control unit, connectable to a communication control unit and a radar control unit, the prioritization control unit being configured to: receive a first time period and a first frequency range from the communication control unit; receive a second time period and a second frequency range from the radar control unit; determine if the first and second time periods at least partially overlap; determine if the first and second frequency ranges at least partially overlap; and prioritize transmission of communication signals or transmission of radar signals based on a pre-defined prioritization rule if the first and second time periods at least partially overlap and the first and second frequency ranges at least partially overlap.

Effects and features of the second, third, fourth and fifth aspects are fully or to a large extent analogous to those described above in connection with the first aspect and vice versa. Embodiments mentioned in relation to the first aspect are fully or largely compatible with the second, third, fourth and fifth aspects and vice versa.

An advantage of some embodiments is that interference is mitigated or prevented.

Another advantage of some embodiments is that efficiency is improved/increased.

Yet another advantage of some embodiments is that power is saved.

A further advantage of some embodiments is that the risk for interference between communication signals and radar signals is reduced or eliminated. Furthermore, if taking interference situations into consideration when determining a radar measurement result, the present invention improves, such as increases, the accuracy of the radar measurement result, and hence more reliable radar signal measurements are achieved.

Yet a further advantage of some embodiments is that lower complexity is achieved, e.g., by utilizing/reusing transceiver units for both radar signals and communication signals.

Another advantage of some embodiments is that all devices operate in a similar manner, e.g., by incorporating the prioritization rule(s) in a standard, thus (further) reducing interference, and/or improving spectral efficiency.

Yet another advantage of some embodiments is that the risk of being interfered and causing inference is reduced or eliminated.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic drawing illustrating a processor according to some embodiments;

FIG. 2 is a flowchart illustrating method steps according to some embodiments;

FIG. 3 is a flowchart illustrating method steps implemented in an apparatus according to some embodiments;

FIG. 4 is a schematic drawing illustrating a computer readable medium according to some embodiments;

FIG. 5 is a schematic drawing illustrating an electronic device according to some embodiments; and

FIG. 6 is a schematic drawing illustrating a prioritization control unit according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

The term “radar signals” below refers generally to backscatter signals, such as radio detection and ranging signals. Radar (Radio Detection and Ranging) is a detection system that uses radio waves to determine the distance to, angle to, or velocity of objects. Furthermore, Radar may also be utilized for sensing of one or more objects in the surroundings of an electronic device. Moreover, a Radar signal may be a sensing signal. In addition, the term “radar signals” below refers to one or more radar signals.

The term “communication signals” below refers to one or more communication signals.

Below is referred to a processor. The processor may be a digital processor. Alternatively, the processor may be a microprocessor, a microcontroller, a central processing unit, a co-processor, a graphics processing unit, a digital signal processor, an image signal processor, a quantum processing unit, or an analog signal processor.

### Embodiments

If radar signals and communication signals are transmitted in the same radio spectrum, it may be beneficial from cost, energy/power consumption and/or complexity perspectives to utilize the same radio transceiver for both radar and communication. Then the radio transceiver can perform both radar and communication signal transmission in a frequency range during a certain time interval. However, there might be events, such as error events, when the device may be requested to perform radar and communication at the same time and frequency. Therefore, there may be a need for prioritization. Such prioritization is preferably performed by a prioritization unit, e.g., comprised in a digital processor. The prioritization unit is monitoring time instances to perform radar and communication operation, respectively. In case a possible collision is determined, the prioritization control unit prioritize either communication or radar operation according to a prioritization rule.

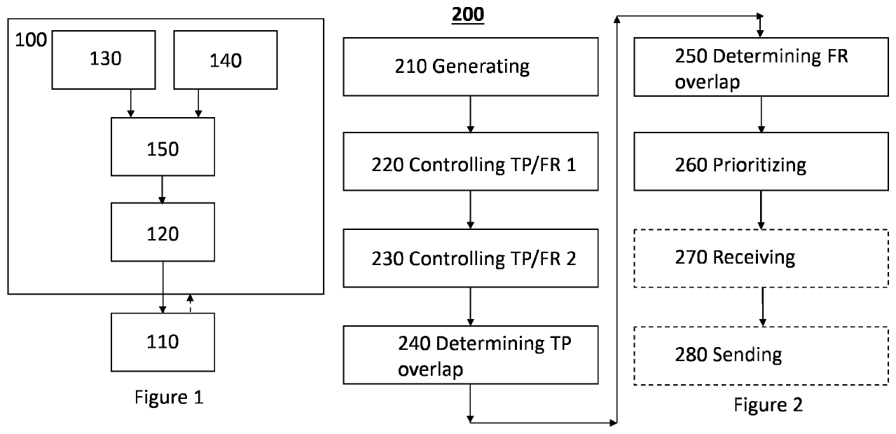

In the following, embodiments will be described where FIG. 1 illustrates a processor 100 for performing radar and communication operations. The processor 100 is connectable or connected to a radio transceiver 110. The radio transceiver 110 is capable of transmitting radar and communication radio signals over at least a first and a second frequency range. In some embodiments, the radio transceiver 110 is capable of receiving communication radio signals over a third frequency range. The first frequency range and/or the second frequency range may be a frequency band or a set of frequency bands, a system bandwidth, or a bandwidth part, i.e., a part of a system bandwidth. In some embodiments, the first and/or the second frequency range comprise a frequency range having millimeter wavelength (mmW; e.g., a frequency band between 10 GHz and 300 GHz, such as the 28 GHz frequency band or the 39 GHz frequency band or the 60 GHz frequency band or the 120 GHz frequency band). Furthermore, in some embodiments, the radio transceiver 110 comprises a radio transmitter. The radio transceiver 110 or the radio transmitter is associated with an antenna (or an antenna unit comprising one or more antennas) for transmitting and/or receiving radio signals, preferably in the mmW range. The processor 100 comprises a signal generator 120 configured to generate communication signals and radar signals. The signal generator 120 takes digital information and maps it to a signal representing the digital signal, that then can be upconverted to a radio signal in the radio transceiver 110 and transmitted via an antenna that, in some embodiments, may be integrated in the same encapsulation as the radio transceiver 110. For mmW transceivers, the antenna is small and hence there may be an advantage in terms of complexity and cost to integrate the antenna in the same encapsulation as the radio transceiver. Alternatively, the processor 100 comprises a first signal generator configured to generate communication signals and a second signal generator configured to generate radar signals. Furthermore, the processor 100 comprises a communication control unit 130. The communication control unit 130 is configured to control a first time period and the first frequency range for transmitting communication signals generated by the signal generator 120. Moreover, the processor 100 comprises a radar control unit 140 configured to control a second time period and the second frequency range for transmitting radar signals generated by the signal generator 120. The processor 100 comprises a prioritization control unit 150. The prioritization control unit 150 is configured to receive the first time period and the first frequency range from the communication control unit 130. Furthermore, the prioritization control unit 150 is configured to receive the second time period and the second frequency range from the radar control unit 140. Moreover, the prioritization control unit 150 is configured to determine if the first and second time periods at least partially overlap. The prioritization control unit 150 is configured to determine if the first and second frequency ranges at least partially overlap. Furthermore, the prioritization control unit 150 is configured to prioritize transmission of communication signals or transmission of radar signals based on or in accordance with or in dependence of a prioritization rule if the first and second time periods at least partially overlap and the first and second frequency ranges at least partially overlap. I.e., the prioritization control unit 150 is configured to, in response to determining that the first and second time periods at least partially overlap and the first and second frequency ranges at least partially overlap, prioritize transmission of communication signals or transmission of radar signals based on a (pre-defined) prioritization rule. The prioritization control unit 150 may indicate to the processor 100 that transmission of communication signals is to be prioritized or that transmission of radar signals is to be prioritized. If the first and second time periods do not overlap and/or the first and second frequency ranges do not overlap, no prioritization is needed (and no indication is sent to the processor 100). Thus, prioritization is, in some embodiments, only performed if the first and second time periods at least partially overlap and the first and second frequency ranges at least partially overlap (and if the first and second time periods do not overlap and/or the first and second frequency ranges do not overlap, no prioritization is performed). In some embodiments, the processor 100 sends the prioritized communication or radar signals to the radio transceiver 110 for transmission via one or more antennas. In some embodiments, the prioritization rule is a pre-defined prioritization rule. Hence, the pre-defined prioritization rule may be stored in a memory unit associated with (e.g., connectable or connected to) the processor 100. Furthermore, in some embodiments, the pre-defined prioritization rule is according to a standard. Thus, in some embodiments, the predefined prioritization rule is the same for a plurality of electronic devices comprising the processor 100 for performing radar and communication operations as disclosed herein. In some embodiments, the standard is a 5G standard or a 6G standard. By incorporating the prioritization rule(s) in a standard, all devices (operating according to the standard) operate in a similar manner, thus reducing interference, and/or improving spectral efficiency. Alternatively, or additionally, the prioritization rule is based on/in accordance with/in dependence of previously transmitted radar and/or communication signals. In some embodiments, if transmission of radar signals was performed after the last transmission of communication signals, the prioritization rule states that transmission of communication signals will be prioritized over transmission of radar signals. Furthermore, in some embodiments, if transmission of communication signals was performed after the last transmission of radar signals, the prioritization rule states that transmission of radar signals will be prioritized over transmission of communication signals. Moreover, in some embodiments, the prioritization rule is based on/in accordance with/in dependence of a type of data packet of or comprised in the communication signal to be transmitted. E.g., if the communication signal(s) to be transmitted comprises one or more packets of a first type, transmission of communication signals will be prioritized over transmission of radar signals and if the communication signal to be transmitted does not comprise one or more packets of the first type (e.g., the communication signal to be transmitted consists of at least one data packet of a second type, different from the first type), transmission of radar signals will be prioritized over transmission of communication signals. In some embodiments, the first type is a retransmission data packet, and the second type is a regular transmission packet, i.e., not a retransmission data packet. In some embodiments the first type is a low latency constraints data packet, i.e., a data packet having low latency constraints, e.g., having lower latency constraints than a latency threshold, which threshold may in some embodiments be 1 millisecond or 100 microseconds, e.g., over the air interface, e.g., over the physical layer and the second type is a high latency constraints data packet data, i.e., a data packet having high latency constraints, e.g., having higher latency constraints than the latency threshold. By prioritizing retransmission data packets and/or low latency constraints data packets, efficiency may be increased. Furthermore, by prioritizing retransmission data packets, latency may be reduced significantly (thus increasing the throughput), e.g., since a delay of a retransmission packet may increase the latency more than the delay of a regular transmission packet. In some embodiments, the prioritization rule is based on/in accordance with/in dependence of a random number or a pseudo-random number. The random number or the pseudo-random number may be a number between 0 and 1, which is generated e.g., by a (pseudo) random number generator associated with (e.g., connectable or connected to) the prioritization unit 150. The generated random number is then compared to a threshold value, such as 0.2, 0.25, 0.3, 0.5, 0.75 or 0.8. If the random number is greater than the threshold value, transmission of communication signals is prioritized. Otherwise (if the random number is not greater than the threshold value) transmission of radar signals is prioritized. The threshold value may be adjustable. By setting the threshold to a suitable value, efficiency may be increased. In some embodiments, the prioritization rule states that transmission of communication signals is always prioritized over transmission of radar signals. By always prioritizing transmission of communication signals over transmission of radar signals, efficiency may be increased and/or complexity may be reduced, e.g., as no conditions need to be checked for deciding which signals to prioritize. In some embodiments, the prioritization rule is a pre-defined prioritization rule according to a standard, such as 5G or 6G and transmission of communication signals is always prioritized over transmission of radar signals. In some embodiments, radar signals are prioritized over communication signals. E.g., radar signals may be prioritized over communication signals for a time period, e.g., 1 second, after a first radar signal has been transmitted. This ensures that if the first radar signal is followed by a pulse train of radar signals, such as 5-50 radar signals (e.g., in order to achieve centimeter or millimeter accuracy), there is enough time to send the full pulse train of radar signals and to receive the reflected pulse train of radar signals before any communication signals are allowed to interrupt the radar signals. In some embodiments, the prioritization rule specifies that radar signals are prioritized over communication signals for a time period after a first radar signal has been transmitted and that transmission of communication signals is prioritized over transmission of radar signals at all other times/during all other time periods. Furthermore, in some embodiments, the prioritization rule states that transmission of radar signals is always prioritized over transmission of communication signals.

In some embodiments, the communication control unit 130 is configured to control a third time period and a third frequency range for receiving communication signals. The radar control unit 140 is configured to control the second time period and the second frequency range for receiving radar signals. Thus, the radar control unit 140 controls the second time period and the second frequency range both for transmitting radar signals generated by the signal generator 120 and for receiving radar signals, such as reflected radar signals, e.g., originating from the transmitted radar signals generated by the signal generator 120 and reflected off an object, such as a coffee cup, and returned to the radio transceiver 110. The prioritization control unit 150 is configured to receive the third time period and the third frequency range from the communication control unit 130. Furthermore, the prioritization control unit 150 is configured to determine if any of the first, second, and third time periods at least partially overlap. Moreover, the prioritization control unit 150 is configured to determine if any of the first, second, and third frequency ranges at least partially overlap. The prioritization control unit 150 is configured to prioritize transmission of communication signals, transmission of radar signals, reception of communication signals or reception of radar signals based on/in accordance with/in dependence of one or more prioritization rules if any of the first, second, and third time periods at least partially overlap and a corresponding first, second, or third frequency range at least partially overlap. I.e., the prioritization control unit 150 is configured to, in response to determining that any of the first, second, and third time periods at least partially overlap and a corresponding first, second, or third frequency range at least partially overlap, prioritize transmission of communication signals, transmission of radar signals, reception of communication signals or reception of radar signals in accordance with one or more (pre-defined) prioritization rules. E.g., if the first and second time periods and the first and second frequency ranges overlap, a first prioritization rule states that transmission of communication signals is prioritized over transmission of radar signals and a second prioritization rule states that reception of radar signals is prioritized over transmission of communication signals (and prioritized over transmission of radar signals). Furthermore, e.g., if the first and third time periods and the first and third frequency ranges overlap, a third prioritization rule states that reception of communication signals is prioritized over transmission of radar signals and a fourth prioritization rule states that reception of radar signals is prioritized over reception of communication signals (and over transmission of radar signals). Moreover, e.g., if the first, second and third time periods and the first, second and third frequency ranges overlap, a fifth prioritization rule states that reception of radar signals is prioritized over transmission and reception of communication signals and a sixth prioritization rule states that reception of radar signals, and transmission and reception of communication signals are prioritized over transmission of radar signals. The prioritization control unit 150 may be configured to (according to the one or more prioritization rules) indicate to the processor 100 which one of transmission of communication signals, transmission of radar signals, reception of communication signals, and reception of radar signals is to be prioritized (in any possible case). The processor 100 may then cause the signal generator 120 to generate the prioritized communication or radar signals. Furthermore, the processor 100 may send the (generated) prioritized communication or radar signals to the radio transceiver 110 (for transmission via one or more antennas) or receive the prioritized communication or radar signals from the radio transceiver 110 (the radio transceiver 110 having received the prioritized communication or radar signals via one or more antennas). More specifically, the prioritization control unit 150 is, in some embodiments, configured to compare the first, second and third time periods to each other. Furthermore, the prioritization control unit 150 is, in some embodiments, configured to compare the first, second and third frequency ranges to each other. Moreover, the prioritization control unit 150 is, in some embodiments, configured to from the comparisons determine which ones (if any) of the first, second and third time periods that overlap. The prioritization control unit 150 is, in some embodiments, configured to determine which ones (if any) of the first, second and third frequency ranges that overlap. Furthermore, the prioritization control unit 150 is, in some embodiments, configured to determine for which ones (if any) of the first, second and third time periods there is an overlap for both time periods and frequency ranges. Moreover, the prioritization control unit 150 is, in some embodiments, configured to apply the one or more prioritization rules (e.g., one or more of the first to sixth prioritization rules) to determine which one of transmission of communication signals, transmission of radar signals, reception of communication signals, and reception of radar signals is to be prioritized. The prioritization control unit 150 is, in some embodiments, configured to indicate to the processor 100 which one of transmission of communication signals, transmission of radar signals, reception of communication signals, and reception of radar signals is to be prioritized. Furthermore, in some embodiments, the one or more prioritization rules are pre-defined. Moreover, in some embodiments, the one or more pre-defined prioritization rules are according to a standard. Thus, in some embodiments, the predefined prioritization rule is the same for a plurality of electronic devices comprising the processor 100 for performing radar and communication operations as disclosed herein. In some embodiments, the standard is a 5G standard or a 6G standard.

FIG. 2 is a flowchart illustrating method steps of a method 200 for the processor 100. The method 200 comprises generating 210 communication signals and/or radar signals. In some embodiments, the generating 210 is performed by a signal generator 120. Alternatively, the generating 210 is performed by a communication signal generator (generating communication signals) and a radar signal generator (generating radar signals). Furthermore, the method 200 comprises controlling 220 a first time period (TP 1) and a first frequency range (FR 1) for transmitting communication signals generated by the signal generator 120. In some embodiments, the controlling 220 is performed by a communication control unit 130. Moreover, the method 200 comprises controlling 230 a second time period (TP 2) and a second frequency range (FR 2) for transmitting radar signals generated by the signal generator 120. In some embodiments, the controlling 220 is performed by a radar control unit 140. The method 200 comprises determining 240 if the first and second time periods at least partially overlap. Furthermore, the method 200 comprises determining 250 if the first and second frequency ranges at least partially overlap. Moreover, the method 200 comprises prioritizing 260 transmission of communication signals or transmission of radar signals based on/in accordance with/in dependence of a prioritization rule if the first and second time periods at least partially overlap and the first and second frequency ranges at least partially overlap, i.e., the method 200 comprises, in response to determining that the first and second time periods at least partially overlap and the first and second frequency ranges at least partially overlap, prioritizing 260 transmission of communication signals or transmission of radar signals based on a prioritization rule. In some embodiments, the prioritization rule is pre-defined. Moreover, in some embodiments, the method 200 comprises receiving 270 from a prioritization unit 150 associated with (connected to or being comprised in) the processor 100 an indication that transmission of communication signals is to be prioritized or that transmission of radar signals is to be prioritized. Furthermore, in some embodiments, the method 200 comprises sending 280 the prioritized communication or radar signals to the radio transceiver 110 for transmission via one or more antennas, preferably via mmW radio frequencies (e.g., frequency bands between 10 GHz and 300 GHz, such as the 28 GHz frequency band or the 39 GHz frequency band or the 60 GHz frequency band or the 120 GHz frequency band). In some embodiments, the generating 210 is performed after prioritizing 260, whereby the method comprises (the processor 100) causing the signal generator 120 to generate the prioritized communication or radar signals and (the processor 100) sending the (generated) prioritized communication or radar signals to the radio transceiver 110 (for transmission via one or more antennas) or receiving the prioritized communication or radar signals from the radio transceiver 110 (the radio transceiver 110 having received the prioritized communication or radar signals via one or more antennas). Moreover, the method may comprise any steps corresponding to the embodiments described above in connection with FIG. 1.

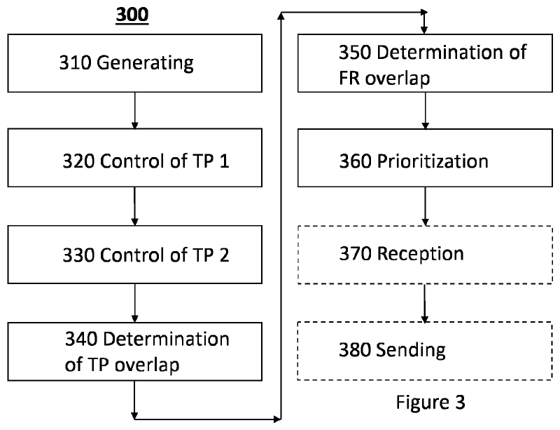

FIG. 3 illustrates method steps implemented in an apparatus 300 according to some embodiments. The apparatus 300 comprises controlling circuitry. The controlling circuitry may be one or more processors, such as the processor 100. The controlling circuitry is configured to cause generation 310 of communication signals and/or radar signals. To this end, the controlling circuitry may be associated with (e.g., operatively connectable, or connected, to) a signal generating unit (e.g., signal generating circuitry or a signal generator, such as the signal generator 120). Furthermore, the controlling circuitry is configured to cause controlling 320 of a first time period and a first frequency range for transmitting communication signals generated by the signal generator 120. To this end, the controlling circuitry may be associated with (e.g., operatively connectable, or connected, to) a first control unit (e.g., first control circuitry or a first controller), such as the communication control unit 130. Moreover, the controlling circuitry is configured to cause controlling 330 of a second time period and a second frequency range for transmitting radar signals generated by the signal generator 120. To this end, the controlling circuitry may be associated with (e.g., operatively connectable, or connected, to) a second control unit (e.g., second control circuitry or a second controller), such as the radar control unit 140. The controlling circuitry is configured to cause determination 340 of if the first and second time periods at least partially overlap. To this end, the controlling circuitry may be associated with (e.g., operatively connectable, or connected, to) a time overlap determination unit (e.g., time overlap determining circuitry, or a time overlap determinator), such as the prioritization control unit 150. Furthermore, the controlling circuitry is configured to cause determination 350 of if the first and second frequency ranges at least partially overlap. To this end, the controlling circuitry may be associated with (e.g., operatively connectable, or connected, to) a frequency overlap determination unit (e.g., frequency overlap determining circuitry or a frequency overlap determinator), such as the prioritization control unit 150. Moreover, the controlling circuitry is configured to cause prioritization 360 of transmission of communication signals or of transmission of radar signals based on/in accordance with/in dependence of a prioritization rule if the first and second time periods at least partially overlap and the first and second frequency ranges at least partially overlap. To this end, the controlling circuitry may be associated with (e.g., operatively connectable, or connected, to) a prioritization unit (e.g., prioritization circuitry or a prioritizer), such as the prioritization control unit 150. In some embodiments, the prioritization rule is pre-defined. Moreover, in some embodiments, the controlling circuitry is configured to cause reception 370 from a prioritization unit 150 associated with (connected to or built-in to) the processor 100 of an indication that transmission of communication signals is to be prioritized or that transmission of radar signals is to be prioritized. To this end, the controlling circuitry may be associated with (e.g., operatively connectable, or connected, to) a reception unit (e.g., receiving circuitry or a receiver). Furthermore, in some embodiments, the controlling circuitry is configured to cause the generation 310 of communication signals and/or radar signals after/following the causing of reception 370. In these embodiments, only the prioritized communication or radar signals are generated. In some embodiments, the controlling circuitry is configured to cause sending 380 of the prioritized communication or radar signals to the radio transceiver 110 for transmission via one or more antennas. To this end, the controlling circuitry may be associated with (e.g., operatively connectable, or connected, to) a sending/transmitting unit (e.g., sending circuitry or a sender). Moreover, any steps of the method described above in connection with FIGS. 1 and 2 may be implemented in the apparatus 300.

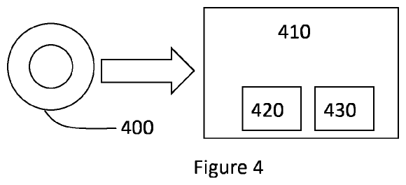

According to some embodiments, a computer program product comprises a non-transitory computer readable medium 400 such as, for example a universal serial bus (USB) memory, a plug-in card, an embedded drive, a digital versatile disc (DVD) or a read only memory (ROM), is provided. FIG. 4 illustrates an example computer readable medium in the form of a compact disc (CD) ROM 400. The computer readable medium has stored thereon, a computer program comprising program instructions. The computer program is loadable into a data processor (PROC) 420, which may, for example, be comprised in a computer or a computing device 410. When loaded into the data processing unit, the computer program may be stored in a memory (MEM) 430 associated with or comprised in the data-processing unit. According to some embodiments, the computer program may, when loaded into and run by the data processing unit, cause execution of method steps according to, for example, the method illustrated in FIG. 2, which is described herein.

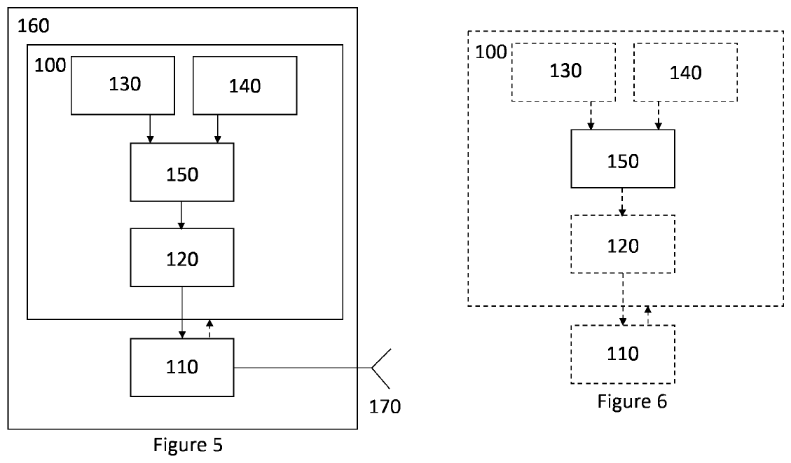

FIG. 5 illustrates an electronic device 160 according to some embodiments. The electronic device 160 comprises the processor 100 (described in connection with FIG. 1; comprising signal generator 120, communication control unit 130, radar control unit 140, and prioritization control unit 150). Furthermore, the electronic device 160 comprises a radio transceiver 110. In some embodiments, the radio transceiver 110 is configured to transmit radar and communication radio signals over (at least) the first and the second frequency ranges. Additionally, or alternatively, the radio transceiver 110 is configured to receive communication radio signals over a third frequency range. In some embodiments, the radio transceiver 110 consists of (is only) a single radio transceiver or radio transmitter, the single radio transceiver/transmitter transmitting and/or receiving both radar and communication radio signals. Thus, a single radio transceiver/transmitter is utilized for transmitting and/or receiving both radar and communication radio signals, i.e., the communications transceiver/transmitter is reused/reutilized for radar signal transmission/reception. Thus, the transmitter is utilized for both radar transmission and communication transmission or the transceiver is utilized for both radar transmission/reception and communication transmission/reception. By reusing/reutilizing the communications transceiver for radar signal transmission/reception energy/power consumption is reduced and/or complexity is reduced. Furthermore, the single radio transceiver/transmitter utilizes, in some embodiments, the same one or more antenna units for both radar transmission/reception and communication transmission/reception. Thus, transmission of both communication signals and radar signals in the same direction is enabled. However, in other embodiments, the radio transceiver/transmitter is/comprises a plurality of transceivers/transmitters and a subset of the plurality of transceivers/transmitters is utilized for both sending (and/or receiving) radar and communication radio signals. In some embodiments, the electronic device 160 comprises one or more antennas 170, each antenna 170 being associated with (connected or connectable to) a respective transceiver/transmitter. Alternatively, the electronic device 160 comprises one or more arrays of antennas, each array being connectable to each of the transceivers/transmitters of the plurality of transceivers/transmitters. In some multi-antenna embodiments, the radio transceiver 110 operates using analog beamforming (where the multiple antennas, via phase shifters and/or switches are connected to a single transceiver), In other multi-antenna embodiments the radio transceiver 110 operates using digital beamforming (where each antenna has its own transceiver). In further embodiments, a hybrid beamforming, which is a combination of the two above may be used. The electronic device 160 may be any kind of device comprising both radar functionality and wireless communication functionality, such as a wireless device, a vehicle, a smartphone, a modem, a laptop, a tablet, a wearable device, a reconfigurable intelligent surface, or an Internet of Things (IoT) device.

FIG. 6 illustrates a prioritization control unit 150 according to some embodiments. The prioritization control unit 150 is connectable or connected to a communication control unit 130. Furthermore, the prioritization control unit 150 is connectable or connected to a radar control unit 140. The prioritization control unit 150 is configured to receive a first time period and a first frequency range from the communication control unit 130. Moreover, the prioritization control unit 150 is configured to receive a second time period and a second frequency range from the radar control unit 140. The prioritization control unit 150 is configured to determine if the first and second time periods at least partially overlap. Furthermore, the prioritization control unit 150 is configured to determine if the first and second frequency ranges at least partially overlap. The prioritization control unit 150 is configured to prioritize transmission of communication signals or transmission of radar signals based on/in accordance with/in dependence of a prioritization rule if the first and second time periods at least partially overlap and the first and second frequency ranges at least partially overlap. I.e., the prioritization control unit 150 is configured to, in response to determining that the first and second time periods at least partially overlap and the first and second frequency ranges at least partially overlap, prioritize transmission of communication signals or transmission of radar signals based on a (pre-defined) prioritization rule. Moreover, the prioritization control unit 150 functions (and is connectable/connected) as described above in connection with one or more of FIGS. 1-5.

### List of Examples

1. A processor (100) for performing radar and communication operations, connectable to a radio transceiver (110) capable of transmitting radar and communication radio signals over at least a first and a second frequency range, the processor (100) comprising:
a signal generator (120) configured to generate communication signals and radar signals;
a communication control unit (130) configured to control a first time period and the first frequency range for transmitting communication signals generated by the signal generator (120);
a radar control unit (140) configured to control a second time period and the second frequency range for transmitting radar signals generated by the signal generator (120); and
a prioritization control unit (150) configured to receive the first time period and the first frequency range from the communication control unit (130), configured to receive the second time period and the second frequency range from the radar control unit (140), configured to determine if the first and second time periods at least partially overlap, configured to determine if the first and second frequency ranges at least partially overlap and configured to prioritize transmission of communication signals or transmission of radar signals based on a prioritization rule if the first and second time periods at least partially overlap and the first and second frequency ranges at least partially overlap.

2. The processor of example 1, wherein the prioritization rule is a pre-defined prioritization rule according to a standard, such as 5G or 6G.

3. The processor of any of examples 1-2, wherein the prioritization rule is based on previously transmitted radar and/or communication signals.

4. The processor of any of examples 1-2, wherein the prioritization rule is based on a type of data packet, such as a retransmission data packet or a low latency constraints data packet, of the communication signal to be transmitted.

5. The processor of any of examples 1-2, wherein the prioritization rule is based on a random number.

6. The processor of any of examples 1-2, wherein the prioritization rule states that transmission of communication signals is always prioritized over transmission of radar signals.

7. The processor of any of examples 1-6,
wherein the communication control unit (130) is further configured to control a third time period and a third frequency range for receiving communication signals;
wherein the radar control unit (140) is further configured to control the second time period and the second frequency range for receiving radar signals;
wherein the prioritization control unit (150) is further configured to receive the third time period and the third frequency range from the communication control unit (130); and
wherein the prioritization control unit (150) is configured to determine if any of the first, second, and third time periods at least partially overlap, configured to determine if any of the first, second, and third frequency ranges at least partially overlap and configured to prioritize transmission of communication signals, transmission of radar signals, reception of communication signals or reception of radar signals based on one or more prioritization rules if any of the first, second, and third time periods at least partially overlap and a corresponding first, second, or third frequency range at least partially overlap.

8. An electronic device (160) comprising the processor (100) of any of examples 1-7 and a radio transceiver (110) configured to transmit radar and communication radio signals over at least the first and the second frequency ranges.

9. A method (200) for a processor (100) comprising:
generating (210) communication signals and radar signals;
controlling (220) a first time period and a first frequency range for transmitting communication signals generated by the signal generator (120);
controlling (230) a second time period and a second frequency range for transmitting radar signals generated by the signal generator (120);
determining (240) if the first and second time periods at least partially overlap;
determining (250) if the first and second frequency ranges at least partially overlap; and
prioritizing (260) transmission of communication signals or transmission of radar signals based on a prioritization rule if the first and second time periods at least partially overlap and the first and second frequency ranges at least partially overlap.

10. A computer program product comprising a non-transitory computer readable medium (400), having stored thereon a computer program comprising program instructions, the computer program being loadable into a data processing unit (420) and configured to cause execution of the method of example 9 when the computer program is run by the data processing unit.

11. A prioritization control unit (150), connectable to a communication control unit (130) and a radar control unit (140), the prioritization control unit (150) being configured to: receive a first time period and a first frequency range from the communication control unit (130);
receive a second time period and a second frequency range from the radar control unit (140);
determine if the first and second time periods at least partially overlap;
determine if the first and second frequency ranges at least partially overlap; and
prioritize transmission of communication signals or transmission of radar signals based on a prioritization rule if the first and second time periods at least partially overlap and the first and second frequency ranges at least partially overlap.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A processor for performing radar and communication operations, connectable to a radio transceiver capable of transmitting radar and communication radio signals over at least a first and a second frequency range, the processor comprising:
a signal generator configured to generate communication signals and radar signals;
a communication control unit configured to control a first time period and the first frequency range for transmitting communication signals generated by the signal generator;
a radar control unit configured to control a second time period and the second frequency range for transmitting radar signals generated by the signal generator; and
a prioritization control unit configured to:
receive the first time period and the first frequency range from the communication control unit,
receive the second time period and the second frequency range from the radar control unit,
determine if the first and second time periods at least partially overlap,
determine if the first and second frequency ranges at least partially overlap, and
prioritize transmission of communication signals or transmission of radar signals based on a pre-defined prioritization rule if the first and second time periods at least partially overlap and the first and second frequency ranges at least partially overlap.

2. The processor of claim 1, wherein the pre-defined prioritization rule is according to a 5G standard or a 6G standard.

3. (canceled)

4. The processor of claim 1, wherein the prioritization rule is based on previously transmitted radar and/or communication signals.

5. The processor of claim 1, wherein the pre-defined prioritization rule is based on a type of data packet.

6. The processor of claim 5, wherein the pre-defined prioritization rule is based on whether the communication signals comprise one or more data packet of a first type.

7. The processor of claim 6, wherein the pre-defined prioritization rule states that if the communication signals comprise one or more data packet of a first type, transmission of communication signals will be prioritized over transmission of radar signals.

8. The processor of claim 7, wherein the pre-defined prioritization rule further states that if the communication signals do not comprise one or more data packet of a first type, transmission of radar signals will be prioritized over transmission of communication signals.

9. The processor of claim 7, wherein the data packet of the first type is a retransmission data packet.

10. The processor of claim 7, wherein the data packet of the first type is a low latency constraints data packet.

11. The processor of claim 7, wherein the data packet of the first type is a low latency constraints data packet or a retransmission data packet.

12. The processor of claim 1, wherein the pre-defined prioritization rule is based on a random number.

13. The processor of claim 1, wherein the pre-defined prioritization rule states that transmission of communication signals is always prioritized over transmission of radar signals.

14. The processor of claim 1, wherein the pre-defined prioritization rule states that transmission of radar signals is prioritized over transmission of communication signals for a time period after a first radar signal has been transmitted.

15. The processor of claim 1, wherein the pre-defined prioritization rule states that transmission of radar signals is always prioritized over transmission of communication signals.

16. The processor of claim 1,
wherein the communication control unit is further configured to control a third time period and a third frequency range for receiving communication signals;
wherein the radar control unit is further configured to control the second time period and the second frequency range for receiving radar signals;
wherein the prioritization control unit is further configured to receive the third time period and the third frequency range from the communication control unit; and
wherein the prioritization control unit is configured to
determine if any of the first, second, and third time periods at least partially overlap,
determine if any of the first, second, and third frequency ranges at least partially overlap, and
prioritize transmission of communication signals, transmission of radar signals, reception of communication signals or reception of radar signals based on one or more pre-defined prioritization rules if any of the first, second, and third time periods at least partially overlap and a corresponding first, second, or third frequency range at least partially overlap.

17. An electronic device comprising the processor of claim 1 and a radio transceiver configured to transmit radar and communication radio signals over the first and the second frequency ranges.

18. The electronic device of claim 17, wherein the radio transceiver consists of a single radio transceiver, wherein the single radio transceiver is configured to transmit and/or receive both radar and communication radio signals, and wherein the single radio transceiver is configured to receive the communication radio signals over a third frequency range.

19. The electronic device of claim 17, wherein the radio transceiver consists of a single radio transmitter, and wherein the single radio transmitter is configured to transmit both radar and communication radio signals.

20. The electronic device of claim 17, wherein the electronic device is a smartphone.

21-24. (canceled)

25. A prioritization control unit, connectable to a communication control unit and a radar control unit, the prioritization control unit being configured to:
receive a first time period and a first frequency range from the communication control unit;
receive a second time period and a second frequency range from the radar control unit;
determine if the first and second time periods at least partially overlap;
determine if the first and second frequency ranges at least partially overlap; and
prioritize transmission of communication signals or transmission of radar signals based on a pre-defined prioritization rule if the first and second time periods at least partially overlap and the first and second frequency ranges at least partially overlap.

26-27. (canceled)
